(19) United States
(12) Patent Application Publication
(10) Pub. No.: US 2007/0269581 A1
(43) Pub. Date: Nov. 22, 2007

(54) Method for producing feed silage

(76) Inventor: Teiko Miyata, Shanghai-shi (CN)

Correspondence Address: SMITH PATENT OFFICE, 1901 PENNSYLVANIA AVENUE N W, SUITE 901, WASHINGTON, DC, 20006, US

(21) Appl. No.: 11/802,248

(22) Filed: May 21, 2007

(30) Foreign Application Priority Data
May 22, 2006 (JP) 2006-141542

(51) Int. Cl. A23K 1/00

(52) U.S. Cl. 426/635

(57) ABSTRACT

To provide a method for producing a feed silage which gives a uniform silage production by uniformly dispersing a mineral component derived from mulberry leaves. A production of feed silage including a mineral component derived from mulberry leaves by mixing 5 to 50 parts by weight of ground mulberry leaves and 95 to 50 parts by weight of one or a plurality of cut coarse feed; adjusting a water content; and subjecting to fermentation, in which the coarse feed may preferably be obtained by cutting leaves of corn or leaves and corn.

### BACKGROUND OF THE INVENTION

1. Field of the Invention

The present invention relates to a method for producing a feed silage, and particularly relates to a method for producing a feed silage capable of providing a mineral to a domestic animals such cattle and horses.

2. Discussion of the Related Art

For example, when giving a feed to milk cattle and beef cattle, feeding have been performed in the steps comprising a making silage from coarse feed such as meadow grasses in a large silo, and a blending this with concentrated feed such as corn, but the blending is onerous.

On the other hand, a method for producing a feed silage, comprising a mixing a coarse feed, a concentrated feed, minerals, and the like, to prepare the perfect feed mixture, a adding lactic acid bacteria thereto, a filling the resultant in bags, then deaerating and hermetically sealing the bags, fermenting and aging under pressure, has been proposed (Japanese Unexamined Patent Publication No. 2002-218914).

In addition, a method for producing a feed silage, comprising a cutting leaves of plant for medicine and feed for domestic animal selected from mulberry, bamboo, kudzu, low bamboo, aloe, ashitaba, and Russian comfrey, a mixing this to a dried wood which is obtained by cutting a straw and/or leaves of corn and being dried, and subjecting to lactate fermentation, has been proposed (Japanese Unexamined Patent Publication No. 62-25939).

### SUMMARY OF THE INVENTION

In these days, it is known that mulberry leaves contain a large amount of mineral component such as calcium and iron, and which leads to the proposition using the mulberry leaves as feed for a domestic animal.

However, in the methods described in Patent Documents 1 and 2, even if coarse feed and dried wood are finely cut, the relative density is largely different from that of mulberry leaves. Accordingly, mulberry leaves are unevenly distributed, even if being mixed for long hours. Even if the leaves are mixed during fermentation, it is difficult to obtain a uniform silage, thus availability of the mineral component of mulberry leaves are low.

Considering such problems, the object of the present invention is to provide a method for producing feed silage capable of producing uniform silage by uniformly dispersing mineral component derived from mulberry leaves.

The method for producing a feed silage including a mineral component derived from mulberry leaves, according to the present invention is characterized in that the silage is produced by mixing 5 to 50 parts by weight of a ground mulberry leaves and 95 to 50 parts by weight, with one or a plurality of cut coarse feed, and adjusting a water content, and subjecting to fermentation.

The main characteristics of the present invention is a point of which mulberry leaves are ground and mixed with coarse feed, and subjected to fermentation. The ground mulberry leaves become a thick condition, and adhered on the surface of coarse feed, thus capable of being uniformly mixed for short time, for a silage which is fermented and aged, mineral component derived from mulberry leaves is uniformly dispersed, and thus uniform silage can be obtained.

It is preferable that 5 to 50 parts by weight of the mulberry leaves are used, since when the mulberry leaves used is less than 5 parts by weight, the mineral component is small, thus the expected effects cannot be obtained, and when greater than 50 parts by weight is added, the effect is not so different.

The method for grinding mulberry leaves is not particularly limited, and may be performed with the use of for example, a rice mortar. In addition, since mulberry leaves are used being ground, a quantity of branch may be contained.

The coarse feed is used being cut, which is preferably cut in the length of 4 cm to 5 cm or less. It is confirmed that when the leaves of corn, or the leaves and corn are used, the feed silage which exhibit an excellent effect for milk cattle and beef cattle.

In addition, the other coarse feed may be used. For example, one or a plurality of alfalfa, straw, timothy, oat hay, Sudan grass, and bacas may be also used.

For the feed silage, one or a plurality of concentrated feed, such as corn, rolled corn, rolled barley, roasted soybean, bran, gluten feed, gluten meal, soybean meal, linseed meal, sesame meal, bean meal, and beet, may be added and mixed for use.

The water content of the mixture of ground mulberry leaves and coarse feed closely influences the fermenting and aging. It is preferable that the content of the mixture before fermentation is 30 to 60% by weight, preferably 40 to 50% by weight. The water content adjustment may be performed by adding water or humidifying with water vapor.

The fermentation may be performed by using lactic acid bacteria existing in nature as it is, or adding lactic acid bacteria. As the lactic acid bacterium is anaerobic bacterium, the fermentation is preferably performed in the condition of being deaerated. For example, the fermentation may be performed with the use of the sealed silo and the drum type fermenter. It is preferable that the fermentation is performed in slightly acidic PH region suitable for the lactic bacterium, in which the miscellaneous bacterium is hard to proliferate, for example, pH 4.0 to 5.5, preferably pH 4.2 to 4.4.

To the mixture of ground mulberry leaves and the coarse feed, an enhancer which enhances fermentation aging, for example, molasses may be added.

Moreover, the feed silage produced by the above described methods is also novel. Subsequently, according to the invention, a feed silage which is obtained by mixing an additive mainly containing ground mulberry leaves, with one or a plurality of cut coarse feed, dispersing and attaching the additive to the surface of the coarse feed, and allowing the fermentation with lactic acid bacteria.

When producing the feed silage, the ground mulberry leaves may be canned in the state of allowing fermentation with lactic acid bacteria, and filling the resultant in bags, which may be mixed to the cut coarse feed, as needed, and the fermentation with a lactic aid bacterium may be performed by water adjacent.

According to the invention, an additive for a coarse feed mainly containing ground mulberry leaves, which is obtained by preserving ground mulberry leaves in a weak acid condition to allow fermentation with lactic acid bacteria may be provided. At this time, the additive for feed silage may be added with an enhancer for the fermentation with lactic acid bacteria such as molasses to be preserved.

Moreover, according to the invention, a feed silage composition is obtained by mixing an additive mainly containing ground mulberry leaves, with one or a plurality of coarse feed, dispersing and attaching the additive to the surface of the coarse feed, fermenting the additive with lactic acid bacteria, and deaerating and packing the additive in the state of allowing fermentation with a lactic acid at the moisture content of 30 to 60% by weight.

### DETAILED DESCRIPTION OF THE PREFERRED EMBODIMENTS

Hereinafter, the present invention will be described in detail, with the reference to specific examples.

### EXAMPLE 1

Mulberry leaves were ground with a millstone until the leaves become sticky condition, 5 kg of mulberry leaves which was ground, and 35 kg of leaves and corn were mixed, a commercially available pH adjuster was added thereto, to adjust the pH in a weak acid region, for example, pH 4.0 to 5.5, and the water content was adjusted so that the water content become 45% by weight, added with lactic acid bacteria. Subsequently, the mixture was subjected to the fermentation by the known method, aged for 30 days, to obtain the feed silage.

The mineral component in the feed silage was analyzed. As the result, calcium: 2966 mg, iron: 44 mg, sodium: 40 mg, potassium: 3101 mg, carotin: 7 mg, vitamin A: 4230IU, vitamin B1: 0.6 mg, vitamin B2: 1.4 mg, vitamin C: 32 mg, fiber: 52 mg, and nicotinic acid: 40 mg are contained in 100 g of the mineral.

Upon giving the obtained feed silage to the milk cattle as feed, the expressed milk was very delicious. Upon giving the obtained feed silage to beef cattle, it is confirmed that the lean of meat is bright pink, and the meat is excellent marbled beef.

Upon giving the feed silage of Example 1 to horse and pig, the health of the horse and pig is improved, and the lean of meat of pig became bright pink.

### EXAMPLE 2

Mulberry leaves were ground with a millstone until the leaves become sticky condition, 5 kg of ground mulberry leaves, and 35 kg of leaves and corn were mixed, pH was adjusted to be in a weak acid region, and the water content was adjusted so that the water content become 45% by weight, added with lactic acid bacteria. Subsequently, the mixture was fermented by the known method, aged for 30 days, to obtain the feed silage.

Upon giving the obtained feed silage to beef cattle, milk cattle, horse, pig, the excellent effects for raising were obtained as compared with the silage comprising of only leaves of corn, though the effects are a little lower than the Example 1.

### EXAMPLE 3

5 kg of ground mulberry leaves, and 35 kg of alfalfa were mixed, pH was adjusted to be in a weak acid region, and the water content was adjusted so that the water content become 50% by weight, added with lactic acid bacterium. Subsequently, the mixture was subjected to the fermentation by the known method, aged for 30 days, to obtain the feed silage.

Upon giving the obtained feed silage to beef cattle, milk cattle, horse, pig, the excellent raising effects were obtained as compared with the silage comprising of only alfalfa.

### EXAMPLE 4

5 kg of mulberry leaves were ground, pH was adjusted in a weak acid region, and which was filled in a bag made from vinyl chloride, and deaerated and hermetically sealed to obtain a packaged additive for feed silage. After storage for 1 week, the package was opened, mixed with 35 kg of cut leaves and corn, the water content was adjusted so that the water content become 45% by weight, added with lactic acid bacteria. Subsequently, the mixture was subjected to the fermentation, aged for 30 days, to obtain the feed silage.

### EXAMPLE 5

Similarly to Example 4, the packaged additive for feed silage was obtained. After storing the composition for 1 week, the package was opened, mixed with 35 kg of cut leaves and corn, the water content was adjusted so that the water content become 45% by weight, added with lactic acid bacteria. Subsequently, the mixture was subjected to the fermentation, aged for 30 days, to obtain the feed silage.

### EXAMPLE 6

Similarly to Example 4, the packaged additive for feed silage was obtained. After storing the composition for 1 week, the package was opened, mixed with 35 kg of cut alfalfa, the water content was adjusted so that the water content become 50% by weight, added with lactic acid bacteria. Subsequently, the mixture was subjected to the fermentation by known method, aged for 30 days, to obtain the feed silage.

### EXAMPLE 7

5 kg of mulberry leaves were ground, added with adequate amount, for example, 50 g of molasses, pH was adjusted in a weak acid region, and which was filled in a bag made from vinyl chloride, and deaerated and hermetically sealed to obtain a packaged additive for feed silage.

After storage for 1 week, the package was opened, mixed with 35 kg of cut leaves and corn, the water content was adjusted so that the water content become 45% by weight, added with lactic acid bacteria. Subsequently, the mixture was subjected to fermentation, aged for 30 days, to obtain the feed silage.

### EXAMPLE 8

5 kg of ground mulberry leaves, and 35 kg of leaves and corn were mixed, pH was adjust in a weak acid region, the water content was adjusted so that the moisture content become 45% by weight, and which was filled in a bag made from vinyl chloride, and hermetically sealed to obtain a packaged additive for feed silage. After storage for 1 week, the package was opened, added with lactic acid bacteria. Subsequently, the mixture was subjected to fermentation, aged for 30 days, to obtain the feed silage.

It is confirmed that upon giving the feed silage obtained in Examples 4 to 8, to beef cattle, milk cattle, horse and pig, the excellent raising effects were obtained, similarly to Examples 1 to 3.

The mixing ratio of ground mulberry and coarse feed, and the kind of coarse feed may be arbitrarily changed depending on the kind of domestic animal to be fed (such as veal calf and adult cattle, milk cattle and beef cattle, colt and adult horse, baby big and adult pig) and the purpose of use (such as for a growth promotion, a health improvement, and a recovery after illness). For example, if a large amount feeding of mineral component is required, the amount of mulberry leaves may be increased.

What is claimed is:

1. A method for producing a feed silage including a mineral component derived from mulberry leaves, comprising the steps of:
mixing 5 to 50 parts by weight of ground mulberry leaves and 95 to 50 parts by weight of one or a plurality of cut coarse feed;
adjusting a water content; and
subjecting to fermentation.

2. The method for producing a feed silage according to claim 1, wherein the coarse feed is obtained by cutting corn leaves.

3. The method for producing a feed silage according to claim 1, wherein the coarse feed is obtained by cutting corn and leaves thereof.

4. The method for producing a feed silage according to claim 1, wherein the coarse feed is one or a plurality of alfalfa, straw, timothy, oat hay, Sudan grass, and bacas.

5. A feed silage, which is obtained by mixing an additive mainly containing ground mulberry leaves, with one or a plurality of cut coarse feed; dispersing and attaching the additive to a surface of the coarse feed; and allowing the fermentation with lactic acid bacteria.

6. An additive for a feed silage, which mainly comprises ground mulberry leaves and is preserved in a weak acid condition to allow fermentation with lactic acid bacteria.

7. The additive for a feed silage according to claim 6, which is obtained by adding an enhancer for fermentation with lactic acid bacteria.

8. A feed silage composition, which is obtained by mixing an additive mainly containing ground mulberry leaves, with one or a plurality of cut coarse feed;
dispersing and attaching the additive to a surface of the coarse feed; and
deaerating and packing the additive in the state of allowing fermentation with lactic acid bacteria at a moisture content of 30 to 60% by weight.
